(19) United States
(12) Patent Application Publication
(10) Pub. No.: US 2023/0269768 A1
(43) Pub. Date: Aug. 24, 2023

(54) RANDOM ACCESS METHOD, TERMINAL DEVICE, AND NETWORK DEVICE

(71) Applicant: VIVO MOBILE COMMUNICATION CO., LTD., Dongguan (CN)

(72) Inventor: Dajie JIANG, Dongguan (CN)

(73) Assignee: VIVO MOBILE COMMUNICATION CO., LTD., Dongguan (CN)

(21) Appl. No.: 18/138,075

(22) Filed: Apr. 22, 2023

Related U.S. Application Data
(63) Continuation of application No. PCT/CN2021/124921, filed on Oct. 20, 2021.

(30) Foreign Application Priority Data
Oct. 23, 2020 (CN) 202011149082.8

(51) Int. Cl. H04W 74/00; H04W 74/08; H04L 1/00

(52) U.S. Cl. CPC H04W 74/008; H04L 1/0026; H04W 74/0833

(57) ABSTRACT

Random access methods, and a terminal device are provided. A random access method includes: transmitting first information used for random access. A preamble carried in the first information is determined based on information of a plurality of target signals. The random access method further includes receiving second information transmitted by a network device. The second information is a random access response for the first information.

### CROSS REFERENCE TO RELATED APPLICATIONS

The present application is a continuation of International Application No. PCT/CN2021/124921, filed on Oct. 20, 2021, which claims priority to Chinese Patent Application No. 202011149082.8, filed on Oct. 23, 2020. The entire contents of each of the above-referenced applications are expressly incorporated herein by reference.

### TECHNICAL FIELD

Embodiments of this application relate to the communications field, and in particular, to a random access method, a terminal device, and a network device.

### BACKGROUND

In a Random Access Channel (RACH) procedure, for example, in a two-step RACH procedure, a terminal needs to determine a Physical Random Access Channel (PRACH) occasion based on an index of a measured Synchronization Signal and PBCH block (SSB) whose serving cell Synchronization Signal (SS) Reference Signal Received Power (RSRP) is greater than an SSB RSRP threshold (rsrp-ThresholdSSB), and transmit an MSGA in the two-step RACH procedure. A base station determines the corresponding SSB index based on related information of the received MSGA, so that an MSGB in the two-step RACH procedure can be transmitted based on the determined SSB index.

A concept of a cell is obsolete in a cell-free communications system. In this case, the communications system includes a plurality of Access Points (APs). A User Equipment (UE) communicates with one or more adjacent APs. When the UE moves between APs, a serving AP of the UE changes. In this case, there is no cell identifier (ID), and no inter-cell handover or cell reselection occurs. Usually, N APs adjacent to the UE serve as serving APs of the UE, and therefore the UE is not subject to interference from the adjacent APs.

In this case, the foregoing RACH procedure is no longer applicable to a cell-free network.

### SUMMARY

Embodiments of this application provide random access methods, a terminal device, and a network device, to implement random access for a cell-free communications system.

According to a first aspect, a random access method is provided. The method is performed by a terminal device, and the method includes: transmitting first information used for random access, where a preamble carried in the first information is determined based on information of a plurality of target signals; and receiving second information transmitted by a network device, where the second information is a random access response for the first information.

According to a second aspect, another random access method is provided. The method is performed by a network device, and the method includes: receiving first information for random access, where a preamble carried in the first information is determined based on information of a plurality of target signals; and transmitting second information, where the second information is a random access response for the first information.

According to a third aspect, a random access apparatus is provided, including: a first processing module, configured to transmit first information used for random access, where a preamble carried in the first information is determined based on information of a plurality of target signals; and a first receiving module, configured to receive second information transmitted by a network device, where the second information is a random access response for the first information.

According to a fourth aspect, another random access apparatus is provided, including: a second receiving module, configured to receive first information for random access, where a preamble carried in the first information is determined based on information of a plurality of target signals; and a second processing module, configured to transmit second information, where the second information is a random access response for the first information.

According to a fifth aspect, a terminal device is provided, where the terminal device includes a processor, a memory, and a computer program or instructions stored in the memory and capable of running on the processor, and when the computer program or instructions are executed by the processor, the steps of the method according to the first aspect are implemented.

According to a sixth aspect, a network device is provided, where the network device includes a processor, a memory, and a computer program or instructions stored in the memory and capable of running on the processor, and when the computer program or instructions are executed by the processor, the steps of the method according to the second aspect are implemented.

According to a seventh aspect, a non-transitory computer readable storage medium is provided, where the non-transitory computer readable storage medium stores a computer program or instructions, and when the computer program or instructions are executed by a processor, the steps of the method according to the first aspect or the second aspect are implemented.

According to an eighth aspect, a computer program product is provided, where the computer program product includes a processor, a memory, and a computer program or instructions stored in the memory and capable of running on the processor, and when the computer program or instructions are executed by the processor, the steps of the method according to the first aspect or the second aspect are implemented.

According to a ninth aspect, a chip is provided, where the chip includes a processor and a communications interface, the communications interface is coupled to the processor, and the processor is configured to run a computer program or instructions, to implement the method according to the first aspect or the second aspect.

According to a random access method, a terminal device, and a network device provided in the embodiments of the present disclosure, first information used for random access is transmitted, where a preamble carried in the first information is determined based on information of a plurality of target signals; and second information transmitted by a network device is received, where the second information is a random access response for the first information, so that random access can be implemented for a cell-free communications system.

### BRIEF DESCRIPTION OF THE DRAWINGS

The accompanying drawings described herein are intended for better understanding of this application, and constitute a part of this application. Exemplary embodiments of this application and descriptions thereof are intended to explain this application, but do not constitute any inappropriate limitation on this application. In the accompanying drawings:

FIG. 1 is a block diagram of a wireless communications system to which an embodiment of this application is applicable.

FIG. 2 is a schematic flowchart of a random access method according to an embodiment of the present disclosure;

FIG. 3 is a schematic flowchart of a random access method according to an embodiment of the present disclosure;

FIG. 4 is a schematic flowchart of a random access method according to an embodiment of the present disclosure;

FIG. 5 is a schematic flowchart of a random access method according to an embodiment of the present disclosure;

FIG. 6 is a schematic flowchart of a random access method according to an embodiment of the present disclosure;

FIG. 7 is a schematic flowchart of a random access method according to an embodiment of the present disclosure;

FIG. 8 is a schematic flowchart of a random access method according to an embodiment of the present disclosure;

FIG. 9 is a schematic structural diagram of a random access apparatus according to an embodiment of the present disclosure;

FIG. 10 is a schematic structural diagram of a random access apparatus according to an embodiment of the present disclosure;

FIG. 11 is a schematic structural diagram of a network device according to another embodiment of the present disclosure; and

FIG. 12 is a schematic structural diagram of a terminal device according to another embodiment of the present disclosure.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by persons of ordinary skill in the art based on the embodiments of this application without creative efforts shall fall within the protection scope of this application.

The terms “first”, “second”, and the like in the specification and claims of this application are used to distinguish between similar objects instead of describing a specific order or sequence. It should be understood that the data used in this way is interchangeable in appropriate circumstances, so that the embodiments of this application can be implemented in other orders than the order illustrated or described herein. In addition, in the specification and claims, “and/or” represents at least one of connected objects, and the character “/” typically represents an “or” relationship between the associated objects.

It should be noted that the technologies described in the embodiments of this application are not limited to a Long Term Evolution (LTE)/LTE-Advanced (LTE-A) system, and may be further used in other wireless communications systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and other systems. The terms “system” and “network” in the embodiments of this application are usually used interchangeably. The described technologies may be used in the aforementioned systems and radio technologies, and may also be used in other systems and radio technologies. However, in the following descriptions, a New Radio (NR) system is described for an illustration purpose, and NR terms are used in most of the following descriptions, but these technologies may also be applied to applications other than an NR system application, for example, a 6^{th} Generation (6G) communications system.

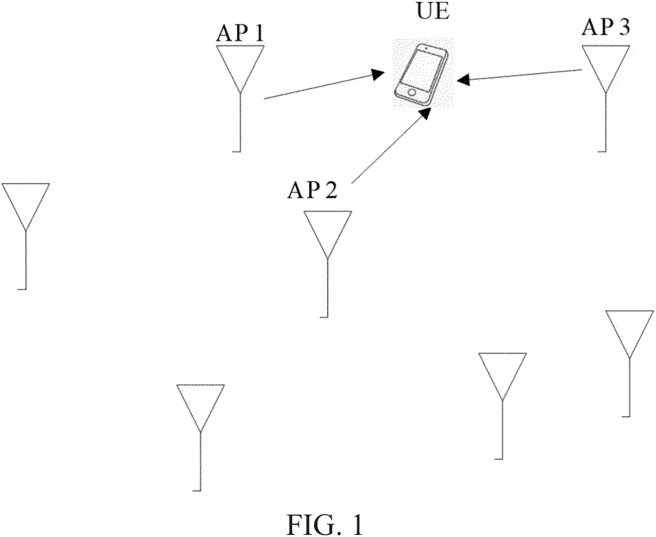

FIG. 1 is a block diagram of a cell-free wireless communications system to which an embodiment of this application is applicable. The wireless communications system includes a terminal 11 and a plurality of APs. The AP may be a network side device 12, or may be a terminal 11. The terminal 11 may also be referred to as a terminal device or a UE. The terminal 11 may be a terminal side device such as a mobile phone, a tablet personal computer, a laptop computer or referred to as a notebook computer, a Personal Digital Assistant (PDA), a palmtop computer, a netbook, an Ultra-Mobile Personal Computer (UMPC), a Mobile Internet Device (MID), a wearable device, Vehicle User Equipment (VUE), or Pedestrian User Equipment (PUE). The wearable device includes a band, a headset, glasses, or the like. It should be noted that a specific type of the terminal 11 is not limited in the embodiments of this application. The network-side device 12 may be a base station or a core network. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmission Reception Point (TRP), or another appropriate term in the art. Provided that the same technical effect is achieved, the base station is not limited to a specific technical term. It should be noted that the base station in the NR system is only used as an example in the embodiments of this application, but a specific type of the base station is not limited.

The following describes in detail a random access method provided in the embodiments of this application with reference to the accompanying drawings and by using specific embodiments and application scenarios thereof.

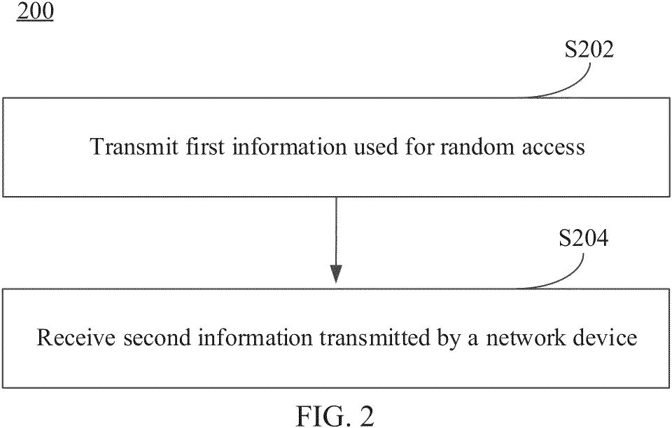

As shown in FIG. 2, an embodiment of the present disclosure provides a random access method 200. The method may be performed by a terminal device. In other words, the method may be performed by software or hardware installed on the terminal device. The method includes the following steps.

S202: Transmit first information used for random access.

A preamble carried in the first information is determined based on information of the plurality of target signals.

A two-step RACH procedure is used as an example for description. Compared with a case that a terminal determines a PRACH occasion based on an index of a measured SSB whose SS-RSRP is greater than a preset threshold, for example, rsrp- ThresholdSSB, and transmits an MSGA in the two-step RACH procedure, in this step, a parameter of the random access preamble is determined based on the information of the plurality of target signals. The plurality of target signals may be transmitted by using a plurality of APs, for example, a plurality of APs in a cell-free system.

In an implementation, the parameter of the preamble includes a preamble index, a frequency domain resource of the preamble, a time domain resource of the preamble, or the like.

In an implementation, the target signal may include an SSB, a Channel State Information Reference Signal (CSI-RS), a Tracking Reference Signal (TRS), a Demodulation Reference Signal (DMRS), another downlink reference signal, or the like.

In an implementation, the plurality of target signals are indicated by a network device by using random access-related signaling. In an implementation, the random access-related signaling carries at least one of the following information: the index of the preamble, a physical random access channel PRACH mask index, and information about a carrier for transmitting the first information.

In some embodiments, the UE may determine an RACH Occasion (RO) of an MSGA based on information of N (N>=1) reference signals or synchronization signals indicated by a base station by using signaling, and a PRACH mask index indicated by the base station by using signaling. A preamble index is determined based on a Random Access Preamble index indicated by the base station by using signaling.

In an implementation, the information of the plurality of target signals varies, and the information of the target signal is at least one of the following information or parameters: an index of the target signal, a synchronization raster sync raster, a frequency domain resource, a time domain resource, a sequence format, a quasi-co-location-related parameter, a beam, a transmission configuration indicator TCI, and an associated transmitting receiving point TRP and access point AP.

In some embodiments, sync rasters of the N reference signals or synchronization signals (for example, SSBs) are different. In some embodiments, frequency domain resources of the N reference signals or synchronization signals are different, for example, carriers or Resource Blocks (RB) are different; or time domain resources of the N reference signals or synchronization signals are different. In some embodiments, sequence formats of the N reference signals or synchronization signals are different. In some embodiments, the N reference signals or synchronization signals are transmitted by using different APs/TRPs, for example, APs/TRP(s) associated with the N SSBs are different. In some embodiments, quasi-co-location-related parameters of the N reference signals or synchronization signals are different, and the like. Examples are not provided one by one herein.

In a case that channel characteristics on a symbol of an antenna port can be deduced from another antenna port, it is considered that the two ports are quasi-co-located (Quasi Co-Location, QCL), and a channel estimation result obtained from one port can be used for the other port. For example, it can be considered that the two ports come from the same emitter. QCL configurations may include a plurality of different signal types, such as a CSI-RS, an SSB, or a Sounding Reference Signal (SRS). For different beams, the network side device may configure QCL configurations corresponding to the beams. The network side device may change a QCL configuration of the UE, to change an operating beam of the terminal.

There are four types of QCL: a type A, a type B, a type C, and a type D. An upper layer transmits a Transmission Configuration Indicator State (TCI-State) to configure QCL. A parameter of the TCI-State is used for configuring a quasi-co-location relationship between one or two downlink reference signals and a DMRS of a PDSCH.

The first information used for random access is the MSGA in the two-step random access procedure. In addition to the preamble, the first information used for random access further includes a payload, namely, uplink data, transmitted by a Physical Uplink Shared Channel (PUSCH) channel.

In an implementation, the first information is transmitted to a plurality of associated TRPs or APs through a plurality of beams, where the plurality of beams correspond to one or more panels of the terminal device. For example, in a target Frequency Range (FR), a preamble needs to be transmitted to two TRPs/APs through two beams of one panel or two beams of two panels respectively.

In an implementation, in a cell-free scenario, a plurality of cells/APs share RACH resources, and PCIs/AP IDs associated with corresponding SSBs may be different. The base station notifies the UE of these association relationships by using broadcast signaling or the like. The RACH resources shared by the plurality of cells/APs may be transmitted by using a SIB1 message. To be specific, in the cell-free scenario, broadcasting of a cell/AP includes information about cell-shared RACH resources corresponding to a plurality of nearby cells/APs. To further reduce RACH overheads in the cell-free scenario, information about a plurality of frequencies at which the UE can initiate access may be broadcast in a cell, and the UE may select one frequency from the plurality of frequencies for initiating access.

S204: Receive second information transmitted by the network device.

The second information is a random access response for the first information.

In an implementation, the second information is an MSGB in a two-step RACH. In this way, the two-step RACH is completed.

In another implementation, the first information is retransmitted in a case that no second information transmitted by the network device is received within a first time range, that is, no M SGB is received; and the process falls back to a four-step random access procedure in a case that the number of retransmissions of the first information MSGA reaches a threshold.

In an implementation, the falling back to a four-step random access procedure may include:
transmitting first access information, for example, an MSG1, of the four-step random access procedure, where a preamble carried in the first access information is determined based on information of a plurality of target signals, where this step may be similar to step S202 of transmitting the first information MSGA, and details are not described herein again;
receiving second access information MSG2 of the four-step random access procedure that is transmitted by the network device, where the second access information is a random access response for the first access information;
transmitting third access information MSG3 of the four-step random access procedure based on the second access information; and
receiving fourth access information MSG4 of the four-step random access procedure that is transmitted by the network device MSG4, where the fourth access information is response information for the third access information.

In this way, the process falls back to the four-step RACH to complete random access in a case that no second information transmitted by the network device is received.

In an implementation, the random access method provided in this embodiment of the present disclosure may be applied to a NR access technology-Unlicensed frequency band (NR-U), Beam Failure Recovery (BFR), and the like.

According to the random access method provided in this embodiment of the present disclosure, first information used for random access is transmitted, where a preamble carried in the first information is determined based on information of a plurality of target signals; and second information transmitted by a network device is received, where the second information is a random access response for the first information, so that random access can be implemented for a cell-free communications system that includes a plurality of APs.

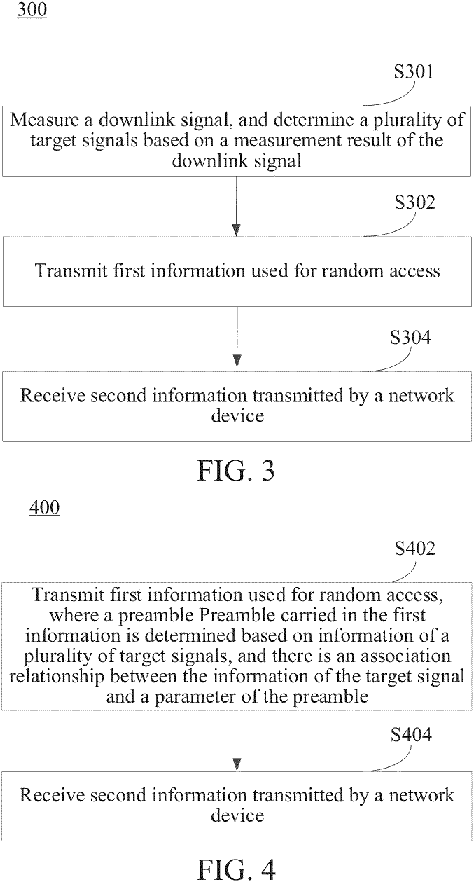

As shown in FIG. 3, an embodiment of the present disclosure provides a random access method 300. The method may be performed by a terminal device. In other words, the method may be performed by software or hardware installed on the terminal device. The method includes the following steps.

S301: Measure a downlink signal, and determine the plurality of target signals based on a measurement result of the downlink signal.

Target measurement values corresponding to the plurality of target signals meet at least one of the following preset conditions.

In an implementation, the plurality of target signals are obtained through measurement. In this case, the target measurement values corresponding to the plurality of target signals meet a preset condition. The preset condition includes at least one of the following:
the target measurement values corresponding to the plurality of target signals are greater than or equal to a first threshold; or
a difference between a plurality of target measurement values corresponding to the plurality of target signals is less than or equal to a second threshold, where
the target measurement values are at least one of an RSRP, a signal-to-noise and interference ratio (SINR), and Reference Signal Received Quality (RSRQ).

In an implementation, the first threshold and/or the second threshold are configured by a network device for the terminal device.

S302: Transmit first information used for random access.

Related descriptions of step S202 in the embodiment of FIG. 2 may be used for this step, and a repeated part is not described herein again.

In an implementation, a physical uplink shared channel PUSCH is transmitted in a case that the target measurement values are the RSRP and RSRP values of the plurality of target signals are all greater than or equal to a third threshold, where the PUSCH is included in the first information or is transmitted after the first information, and the third threshold is greater than or equal to the first threshold. For example, in the case of the two-step RACH, the PUSCH is included in the first information. In the case of falling back to the four-step RACH, the PUSCH is transmitted after the first information, for example, the preamble.

The UE may indirectly notify, by using preamble-related information of an MSGA, a base station of information about N (N>=1) SSBs determined through measurement; or may directly notify, through a PUSCH of an MSGA, the base station of the information about the N (N>=1) SSBs determined through measurement.

In an implementation, the first information used for random access is transmitted in a case that the target measurement values are the RSRP and RSRP values of the plurality of target signals are all less than a third threshold, where the first information includes the preamble, and the third threshold is greater than or equal to the first threshold. In this case, no PUSCH is transmitted.

In an implementation, the first information used for random access is transmitted in a case that the target measurement values are the RSRP and RSRP values of the plurality of target signals are all less than a third threshold, where the first information includes the preamble, and the third threshold is greater than or equal to the first threshold. In this case, no PUSCH is transmitted.

S304: Receive second information transmitted by the network device.

Related descriptions of step S304 in the embodiment of FIG. 2 may be used for this step, and a repeated part is not described herein again.

According to the random access method provided in this embodiment of the present disclosure, first information used for random access is transmitted, where a preamble carried in the first information is determined based on information of a plurality of target signals; and second information transmitted by a network device is received, where the second information is a random access response for the first information, so that random access can be implemented for a cell-free communications system that includes a plurality of APs.

As shown in FIG. 4, an embodiment of the present disclosure provides a random access method 400. The method may be performed by a terminal device. In other words, the method may be performed by software or hardware installed on the terminal device. The method includes the following steps.

S402: Transmit first information used for random access, where a preamble carried in the first information is determined based on information of a plurality of target signals, and there is an association relationship between the information of the target signal and a parameter of the preamble.

Related descriptions of step S202 in the embodiment of FIG. 2 and step S302 in the embodiment of FIG. 3 may be used for this step, and a repeated part is not described herein again.

In an implementation, there is an association relationship between the information of the target signal and the parameter of the preamble, where the parameter of the preamble includes at least one of an index of the preamble, a frequency domain resource of the preamble, and a time domain resource of the preamble. Th information of the target signal includes: an index of the target signal, a synchronization raster (sync raster), a frequency domain resource, a time domain resource, a sequence format, a quasi-co-location-related parameter, a beam, a transmission configuration indicator TCI, and an associated transmitting receiving point TRP and access point AP.

For example, Table 1 shows that there is an association relationship between the information of the target signal and the parameter of the preamble.

TABLE 1

| | |
|---|---|
| SSB information | Preamble-related information of an MSGA |
| SSB1, SSB2 | {Preamble index, preamble time domain resource, preamble frequency domain resource} combination 1 |
| SSB2, SSB3 | {Preamble index, preamble time domain resource, preamble frequency domain resource} combination 2 |
| SSB1, SSB3 | {Preamble index, preamble time domain resource, preamble frequency domain resource} combination 3 |
| SSB2, SSB3, SSB1 | {Preamble index, preamble time domain resource, preamble frequency domain resource} combination 4 |
| SSB1 | {Preamble index, preamble time domain resource, preamble frequency domain resource} combination 5 |
| SSB2 | {Preamble index, preamble time domain resource, preamble frequency domain resource} combination 6 |
| SSB3 | {Preamble index, preamble time domain resource, preamble frequency domain resource} combination 7 |

In an implementation, there is an association relationship between the index of the preamble and a preamble sequence format, and the preamble sequence format includes at least one of a sequence length, an SCS, and a root sequence.

In an implementation, the information of the plurality of target signals includes a difference between a plurality of target measurement values corresponding to the plurality of target signals. That is, there is an association relationship between the parameter of the preamble and the difference between the plurality of target measurement values corresponding to the plurality of target signals. For example, a difference between RSRPs of two strongest SSBs (the SSB 1 and the SSB3) detected by the UE being 1 dB and a difference between RSRPs of two strongest SSBs (the SSB1 and the SSB3) detected by the UE being 4 dB correspond different {preamble index, preamble time domain resource, preamble frequency domain resource} combinations.

In an implementation, the association relationship between the information of the target signal and the parameter of the preamble is a one-to-one correspondence.

In an implementation, parameters of the preamble that correspond to the information of the plurality of target signals are determined based on the association relationship between the information of the target signal and the parameter of the preamble. For example, the determining, based on the association relationship between the information of the target signal and the parameter of the preamble, parameters of the preamble that correspond to the information of the plurality of target signals may include two implementations.

Manner 1: ROs associated with the plurality of target signals are determined, and a first target preamble is determined from a plurality of preambles corresponding to one or more ROs associated with the plurality of target signals.

Manner 2: ROs associated with the plurality of target signals are determined; one RO is selected from the ROs associated with the plurality of target signals, where a preamble corresponding to the selected RO is used as a preamble candidate set; and a second target preamble is determined from the preamble candidate set.

At least one of information of an associated PUSCH and information of an associated demodulation reference signal is determined based on the parameter of the preamble.

For example, the first information further includes at least one of an uplink shared channel PUSCH and a demodulation reference signal DMRS, and transmission information of the uplink shared channel PUSCH or transmission information of the demodulation reference signal DMRS is determined based on the preamble.

For example, after selecting an RO and a preamble index of the RO, the UE determines, by using a predefined mapping rule, a PUSCH Occasion (PO) and a DMRS resource that are used for transmitting the PUSCH.

The PUSCH includes at least one of the following:
at least one target signal that meets an RSRP threshold; or
an RSRP value of at least one target signal that meets an RSRP threshold.

S404: Receive second information transmitted by the network device.

Related descriptions of step S304 in the embodiment of FIG. 2 may be used for this step, and a repeated part is not described herein again.

According to the random access method provided in this embodiment of the present disclosure, first information used for random access is transmitted, where a preamble carried in the first information is determined based on information of a plurality of target signals; and second information transmitted by a network device is received, where the second information is a random access response for the first information, so that random access can be implemented for a cell-free communications system that includes a plurality of APs.

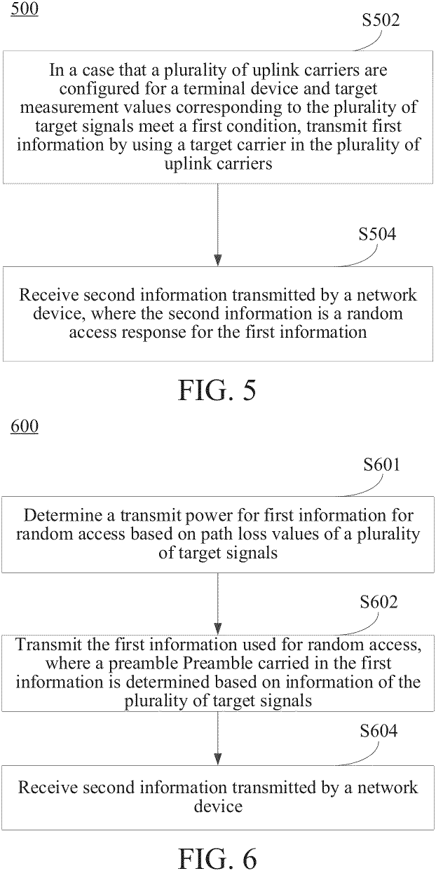

As shown in FIG. 5, an embodiment of the present disclosure provides a random access method 500. The method may be performed by a terminal device. In other words, the method may be performed by software or hardware installed on the terminal device. The method includes the following steps.

S502: In a case that a plurality of uplink carriers are configured for the terminal device and target measurement values corresponding to the plurality of target signals meet a first condition, transmit the first information by using a target carrier in the plurality of uplink carriers.

Related descriptions of step S202 in the embodiment of FIG. 2, step S302 in the embodiment of FIG. 3, and step S402 in the embodiment of FIG. 4 may be used for this step, and a repeated part is not described herein again.

In an implementation, before the first information used for random access is transmitted, a random access Radio Network Temporary Identifier (RNTI) may be determined based on the target carrier.

In an implementation, in a case that the target measurement values corresponding to the plurality of target signals are greater than a fourth threshold, the first information is transmitted by using a first carrier in the plurality of uplink carriers; or in a case that a target measurement value corresponding to at least one of the plurality of target signals is not greater than the fourth threshold, the first information is transmitted by using a second carrier in the plurality of uplink carriers, where a frequency of the first carrier is higher than that of the second carrier.

For example, in a case that a plurality of uplink carriers, such as a high-frequency carrier and a low-frequency carrier, are configured for the UE to transmit a preamble, if RSRPs/SINRs/RSRQ of N reference signals or synchronization signals are all less than a fourth threshold, the UE transmits an MSGA by using a target carrier (for example, a carrier with a lower frequency); otherwise, transmits the MSGA by using another carrier (for example, a carrier with a higher frequency).

A calculation formula for determining a Random Access RNTI (RA-RNTI) is related to a specific carrier used for transmitting the preamble, for example, is related to a carrier ID.

In an implementation, a scrambling sequence used for PUSCH data of the first information is as follows:

$${\text{C}}_{\text{init}} = {n}_{\text{RNTI}} \times {2}^{16} + {n}_{\text{RAPID}} \times {2}^{10} + {n}_{\text{ID}} , \text{where}$$

^{η}RBTI is the random access RNTI and is determined by a time-frequency resource location of a random access occasion RO, ^{η}RAPlD indicates an index of the preamble, and η_{ID} indicates a cell identifier ID.

S504: Receive second information transmitted by a network device, where the second information is a random access response for the first information.

Related descriptions of step S204 in the embodiment of FIG. 2, step S304 in the embodiment of FIG. 3, and step S404 in the embodiment of FIG. 4 may be used for this step, and a repeated part is not described herein again.

According to the random access method provided in this embodiment of the present disclosure, first information used for random access is transmitted, where a preamble carried in the first information is determined based on information of a plurality of target signals; and second information transmitted by a network device is received, where the second information is a random access response for the first information, so that random access can be implemented for a cell-free communications system that includes a plurality of APs.

As shown in FIG. 6, an embodiment of the present disclosure provides a random access method 600. The method may be performed by a terminal device. In other words, the method may be performed by software or hardware installed on the terminal device. The method includes the following steps.

S601: Determine a transmit power for the first information for random access based on path loss values of the plurality of target signals.

Each target signal corresponds to a respective path loss value. RSRPs of a plurality of SSBs associated with the first information are considered. For example, the plurality of SSBs are transmitted by using a plurality of APs. This means that losses of paths from the plurality of APs to the terminal are considered in the transmit power for the first information.

S602: Transmit the first information used for random access, where a preamble carried in the first information is determined based on information of the plurality of target signals.

Related descriptions of step S202 in the embodiment of FIG. 2, step S302 in the embodiment of FIG. 3, step S402 in the embodiment of FIG. 4, and step S502 in the embodiment of FIG. 5 may be used for this step, and a repeated part is not described herein again.

S604: Receive second information transmitted by a network device.

The second information is a random access response for the first information.

Related descriptions of step S204 in the embodiment of FIG. 2, step S304 in the embodiment of FIG. 3, step S404 in the embodiment of FIG. 4, and step S504 in the embodiment of FIG. 5 may be used for this step, and a repeated part is not described herein again.

According to the random access method provided in this embodiment of the present disclosure, first information used for random access is transmitted, where a preamble carried in the first information is determined based on information of a plurality of target signals; and second information transmitted by a network device is received, where the second information is a random access response for the first information, so that random access can be implemented for a cell-free communications system that includes a plurality of APs.

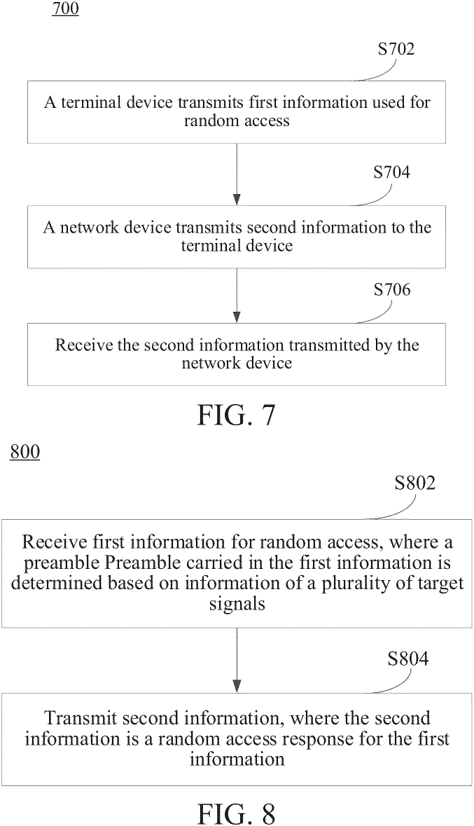

As shown in FIG. 7, an embodiment of the present disclosure provides a random access method 700. The method may be performed by a terminal device and/or a network device. In other words, the method may be performed by software or hardware installed on the terminal device and/or the network device. The method includes the following steps.

S702: The terminal device transmits first information used for random access.

A preamble carried in the first information is determined based on information of a plurality of target signals.

Related descriptions of step S202 in the embodiment of FIG. 2, step S302 in the embodiment of FIG. 3, step S402 in the embodiment of FIG. 4, step S502 in the embodiment of FIG. 5, and step S602 in the embodiment of FIG. 6 may be used for this step, and a repeated part is not described herein again.

Related descriptions of step S204 in the embodiment of FIG. 2, step S304 in the embodiment of FIG. 3, step S404 in the embodiment of FIG. 4, step S504 in the embodiment of FIG. 5, and step S604 in the embodiment of FIG. 6 may be used for this step, and a repeated part is not described herein again.

S704: The network device transmits second information to the terminal device.

A transmitting manner of transmitting the second information includes one of the following manners.

Manner 1: A plurality of pieces of second information are transmitted based on a plurality of quasi-co-location-related parameters corresponding to the plurality of target signals. For example, a base station transmits an MSGB to the UE by using N quasi-co-location-related parameters corresponding to N SSB indexes, where the N quasi-co-location-related parameters correspond to different TBs or the same TB, and N ≥ 2 An upper layer configures the quasi-co-location-related parameters by using a TCI-State.

Manner 2: The second information is transmitted based on at least one first quasi-co-location-related parameter corresponding to the plurality of target signals. For example, the base station transmits an MSGB to the UE by using X (N > X > 1) quasi-co-location-related parameters of N quasi-co-location-related parameters corresponding to N SSB indexes. An upper layer configures QCL by using a TCI-State.

Manner 3: The second information is transmitted based on a second quasi-co-location-related parameter, where the second quasi-co-location-related parameter is different from the plurality of quasi-co-location-related parameters corresponding to the plurality of target signals. In other words, the second information is transmitted by using a second quasi-co-location-related parameter corresponding to a signal other than the target signals. For example, the base station transmits an MSGB to the UE by using a quasi-co-location-related parameter corresponding to an SSB different from the N SSB indexes. In this case, the UE needs to detect the new SSB and receive the MSG2 in a four-step RACH. Different SSBs or quasi-co-location-related parameters may correspond to one or more APs.

In an implementation, in a case that a two-step RACH is used, the second information is an MSGB in the two-step RACH.

In another implementation, in the two-step RACH, after the UE transmits an MSGA, in a case that the base station can correctly detect a preamble of the MSGA but fails to detect a PUSCH message, the process may fall back from the two-step RACH to a four-step RACH. In this case, the base station may feed back a FallbackRAR, which is similar to an MSG2 in the four-step RACH, and is used for scheduling the UE to transmit an MSG3. A manner of transmitting, by the base station, the FallbackRAR to the UE is also similar to the foregoing manners 1 to 3.

For example, in a manner 1, the base station transmits the FallbackRAR to the UE by using N quasi-co-location-related parameters corresponding to N SSB indexes, where the N quasi-co-location-related parameters correspond to different TBs or the same TB. In a manner 2, the base station transmits the FallbackRAR to the UE by using X (N > X > 1) quasi-co-location-related parameters of N quasi-co-location-related parameters corresponding to N SSB indexes. In a manner 3, the base station transmits an MSG2 to the UE by using a quasi-co-location-related parameter corresponding to an SSB different from the N SSB indexes. In this case, the UE needs to detect the new SSB and receive the corresponding FallbackRAR. Different SSBs or quasi-co-location-related parameters may correspond to one or more APs.

In an implementation, after receiving the MSGA, the base station may determine information about an AP or a beam for transmitting the MSGB, thereby enhancing transmission reliability of the MSGA and the MSGB, and improving reliability of a random access procedure in a cell-free network.

Correspondingly, in S706, the terminal device receives the second information transmitted by the network device, where the second information is a random access response for the first information.

For example, the terminal device receives one or more pieces of second information transmitted by the network device, where target information in the second information is determined by the network device based on the first information, the second information includes first parameter information, the indicated first parameter information is different from the information of the target signals. The first parameter information indicated in the second information includes at least one of an AP, a TRP, a beam, quasi-co-location, and a transmission configuration indicator TCI.

In an implementation, in a case that the number of APs associated with the plurality of target signals is greater than or equal to 2, a second time interval between a time at which the terminal device transmits the first information and a time at which the terminal device receives the second information is greater than or equal to a first time interval, where the first time interval is a time interval between a time at which the terminal device transmits the first information and a time at which the terminal device receives the second information in a case that the number of APs associated with the plurality of target signals is 1.

For example, in a case that the number of APs associated with N SSBs associated with the MSGA is greater than or equal to 2 and a time interval is X1, two or more APs need to receive the MSGA and perform joint reception in uplink, and received data needs to be aggregated among a plurality of APs. As a result, a delay T1 of processing the MSGA by the base station is greater than a delay T2 of processing the MSGA by one AP. For another example, in a case that the number of APs associated with N SSBs associated with the MSGA is and a time interval is X2 (X2 <= X1).

In a case that the MSGA transmitted by the UE is successfully detected and the MSGB fed back by the base station includes a SuccessRAR for the user, the UE feeds back a HARQ-ACK message indicating that the MSGB is successfully received, which indicates that the UE successfully completes the random access procedure.

In another implementation, in the two-step RACH, after the UE transmits an MSGA, in a case that the base station can correctly detect a preamble of the MSGA but fails to detect a PUSCH message, the process may fall back from the two-step RACH to a four-step RACH. In this case, the base station may feed back a FallbackRAR, which is similar to second information MSG2 in the four-step RACH, and is used for scheduling the UE to transmit an MSG3.

A manner of transmitting, by the base station, the FallbackRAR to the UE is also similar to the foregoing manners 1 to 3. Correspondingly, the terminal device receives the FallbackRAR transmitted by the network device, and transmits third information, for example, an MSG3 in the four-step RACH, based on the second information.

The MSG3 is transmitted to the base station. In a case that the MSG3 is retransmitted due to a transmission failure, the preamble is not transmitted again, because the preamble has been successfully transmitted in the two-step RACH.

The terminal receives fourth information transmitted by the network device, where the fourth information is response information for the third information. In this way, in a case that demodulation of the PUSCH message fails, the process may fall back from the two-step RACH to the four-step RACH, to complete random access.

According to the random access method provided in this embodiment of the present disclosure, first information used for random access is transmitted, where a preamble carried in the first information is determined based on information of a plurality of target signals; and second information transmitted by a network device is received, where the second information is a random access response for the first information, so that random access can be implemented for a cell-free communications system that includes a plurality of APs.

In addition, in an implementation different from the embodiments of FIG. 2 to FIG. 7, that the preamble carried in the first information is determined based on the information of the plurality of target signals may include: The preamble is determined based on information of one of the plurality of target signals.

The random access method according to the embodiments of the present disclosure is described above in detail with reference to FIG. 2 to FIG. 7. A random access method according to another embodiment of the present disclosure is described below in detail with reference to FIG. 8. It may be understood that interaction between a network device and a terminal device described from the network device side is the same as or corresponds to the description on the terminal device side in the methods shown in FIG. 2 to FIG. 7. Related descriptions are properly omitted to avoid repetition.

FIG. 8 is a schematic diagram of an implementation process of a random access method according to an embodiment of the present disclosure. The method may be applied to a network device side. As shown in FIG. 8, the method 800 includes the following steps.

S802: Receive first information for random access, where a preamble carried in the first information is determined based on information of a plurality of target signals.

Related descriptions of step S202 in the embodiment of FIG. 2, step S302 in the embodiment of FIG. 3, step S402 in the embodiment of FIG. 4, step S502 in the embodiment of FIG. 5, step S602 in the embodiment of FIG. 6, and step S702 in the embodiment of FIG. 7 may be used for this step, and a repeated part is not described herein again.

S804: Transmit second information, where the second information is a random access response for the first information.

Related descriptions of step S204 in the embodiment of FIG. 2, step S304 in the embodiment of FIG. 3, step S404 in the embodiment of FIG. 4, step S504 in the embodiment of FIG. 5, step S604 in the embodiment of FIG. 6, and step S704 in the embodiment of FIG. 7 may be used for this step, and a repeated part is not described herein again.

It should be noted that the random access method provided in the embodiments of this application may be performed by a random access apparatus, or by a control module that is in the apparatus and that is configured to load the foregoing method. In the embodiments of this application, the random access method provided in the embodiments of this application is described by using an example in which a random access configuration apparatus performs the random access method.

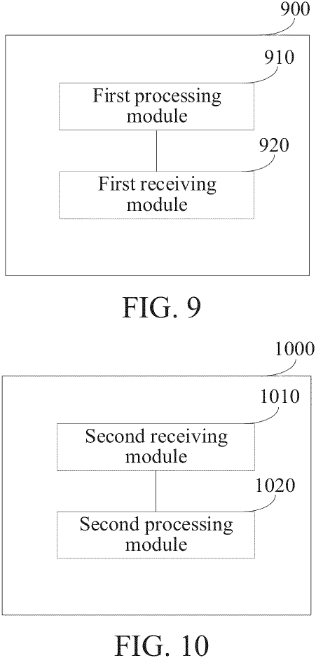

FIG. 9 is a schematic structural diagram of a random access apparatus according to an embodiment of the present disclosure. As shown in FIG. 9, the random access apparatus 900 includes a first processing module 910 and a first receiving module 920.

The first processing module 910 is configured to transmit first information used for random access, where a preamble carried in the first information is determined based on information of a plurality of target signals. The first receiving module 920 is configured to receive second information transmitted by a network device, where the second information is a random access response for the first information.

In an implementation, the information of the plurality of target signals varies, and the information of the target signal is at least one of the following:
an index of the target signal, a synchronization raster sync raster, a frequency domain resource, a time domain resource, a sequence format, a quasi-co-location-related parameter, a beam, a transmission configuration indicator TCI, and an associated transmitting receiving point TRP and access point AP.

In an implementation, the first processing module 910 is configured to: measure a downlink signal; and determine the plurality of target signals based on a measurement result of the downlink signal, where target measurement values corresponding to the plurality of target signals meet at least one of the following preset conditions:
the target measurement values corresponding to the plurality of target signals are greater than or equal to a first threshold; or
a difference between a plurality of target measurement values corresponding to the plurality of target signals is less than or equal to a second threshold, where
the target measurement values are at least one of a reference signal received power RSRP, a signal-to-noise and interference ratio SINR, and reference signal received quality RSRQ.

In an implementation, the first threshold and/or the second threshold are configured by a network device for the terminal device.

In an implementation, a physical uplink shared channel PUSCH is transmitted in a case that the target measurement values are the RSRP and RSRP values of the plurality of target signals are all greater than or equal to a third threshold, where the PUSCH is included in the first information or is transmitted after the first information, and the third threshold is greater than or equal to the first threshold.

In an implementation, the first processing module 910 is configured to transmit the first information used for random access in a case that the target measurement values are the RSRP and RSRP values of the plurality of target signals are all less than a third threshold, where the third threshold is greater than or equal to the first threshold.

In an implementation, the plurality of target signals are indicated by a network device by using random access-related signaling.

In an implementation, the random access-related signaling carries at least one of the following information:
an index of the preamble, a physical random access channel PRACH mask index, and information about a carrier for transmitting the first information.

In an implementation, there is an association relationship between the information of the target signal and the parameter of the preamble, where
the parameter of the preamble includes at least one of the index of the preamble, a frequency domain resource of the preamble, and a time domain resource of the preamble.

In an implementation, there is an association relationship between the index of the preamble and a preamble sequence format, and the preamble sequence format includes at least one of a sequence length, a subcarrier spacing SCS, and a root sequence.

In an implementation, the information of the plurality of target signals includes a difference between a plurality of target measurement values corresponding to the plurality of target signals.

In an implementation, the association relationship between the information of the target signal and the parameter of the preamble is a one-to-one correspondence.

In an implementation, the first processing module 910 is configured to determine, based on the association relationship between the information of the target signal and the parameter of the preamble, parameters of the preamble that correspond to the information of the plurality of target signals.

In an implementation, the first processing module 910 is configured to determine random access occasions ROs associated with the plurality of target signals, and determine a first target preamble from a plurality of preambles corresponding to the ROs associated with the plurality of target signals.

In an implementation, the first processing module 910 is configured to: determine ROs associated with the plurality of target signals;
select one RO from the ROs associated with the plurality of target signals, where a preamble corresponding to the selected RO is used as a preamble candidate set; and
determine a second target preamble from the preamble candidate set.

In an implementation, the first processing module 910 is configured to: after the first information used for random access is transmitted, retransmit the first information in a case that no second information transmitted by the network device is received within a first time range; and
fall back to a four-step random access procedure in a case that the number of retransmissions of the first information reaches a threshold.

In an implementation, the first processing module 910 is configured to: transmit first access information of the four-step random access procedure, where a preamble carried in the first access information is determined based on information of a plurality of target signals;
receive second access information of the four-step random access procedure that is transmitted by the network device, where the second access information is a random access response for the first access information;
transmit third access information of the four-step random access procedure based on the second access information; and
receive fourth access information of the four-step random access procedure that is transmitted by the network device, where the fourth access information is response information for the third access information.

In an implementation, the first information further includes at least one of an uplink shared channel PUSCH and a demodulation reference signal DMRS, and transmission information of the uplink shared channel PUSCH or transmission information of the demodulation reference signal DMRS is determined based on the preamble.

In an implementation, the PUSCH includes at least one of the following:
at least one target signal that meets an RSRP threshold; or
an RSRP value of at least one target signal that meets an RSRP threshold.

In an implementation, the first processing module 910 is configured to: in a case that a plurality of uplink carriers are configured for the terminal device and target measurement values corresponding to the plurality of target signals meet a first condition, transmit the first information by using a target carrier in the plurality of uplink carriers.

In an implementation, that the first processing module 910 is configured to: in a case that a plurality of uplink carriers are configured for the terminal device and target measurement values corresponding to the plurality of target signals meet a first condition, transmit the first information by using a target carrier in the plurality of uplink carriers includes:
in a case that the target measurement values corresponding to the plurality of target signals are greater than a fourth threshold, transmitting the first information by using a first carrier in the plurality of uplink carriers; or
in a case that a target measurement value corresponding to at least one of the plurality of target signals is not greater than the fourth threshold, transmitting the first information by using a second carrier in the plurality of uplink carriers, where a frequency of the first carrier is higher than that of the second carrier.

In an implementation, the first processing module 910 is configured to: before transmitting the first information used for random access, determine a random access radio network temporary identifier RNTI based on the target carrier.

In an implementation, the first processing module 910 is configured to: before transmitting the first information used for random access, determine a transmit power for the first information for random access based on path loss values of the plurality of target signals, where each target signal corresponds to a respective path loss value.

In an implementation, that the first processing module 910 is configured to transmit first information used for random access includes: transmitting the first information to a plurality of associated TRPs or APs through a plurality of beams respectively, where the plurality of beams correspond to one or more panels of the terminal device.

In an implementation, the receiving second information transmitted by a network device includes one of the following manners:
receiving a plurality of pieces of second information based on a plurality of quasi-co-location-related parameters corresponding to the plurality of target signals;
receiving the second information based on at least one first quasi-co-location-related parameter corresponding to the plurality of target signals; or
receiving the second information based on a second quasi-co-location-related parameter, where the second quasi-co-location-related parameter is different from the plurality of quasi-co-location-related parameters corresponding to the plurality of target signals.

In an implementation, in a case that the number of APs associated with the plurality of target signals is greater than or equal to 2, a second time interval between a time at which the terminal device transmits the first information and a time at which the terminal device receives the second information is greater than or equal to a first time interval, where the first time interval is a time interval between a time at which the terminal device transmits the first information and a time at which the terminal device receives the second information in a case that the number of APs associated with the plurality of target signals is 1.

In an implementation, the second information includes first parameter information, and the first parameter information is different from the information of the target signal.

In an implementation, the first parameter information includes at least one of an AP, a TRP, a beam, quasi-co-location, and a transmission configuration indicator TCI.

In an implementation, the first processing module 910 is configured to: transmit third information based on the second information, where the second information is used for scheduling the terminal device to transmit the third information; and
receive fourth information transmitted by the network device, where the fourth information is response information for the third information.

In an implementation, the first information is an MSGA in a two-step random access procedure, and/or the second information is an MSGB in the two-step random access procedure.

The random access apparatus in this embodiment of this application may be an apparatus, or may be a component, an integrated circuit, or a chip in a terminal. The apparatus may be a mobile electronic device, or may be a non-mobile electronic device. For example, the mobile electronic device may be a mobile phone, a tablet computer, a notebook computer, a palmtop computer, a vehicle-mounted electronic device, a wearable device, a UMPC, a netbook, or a PDA, and the non-mobile electronic device may be a server, a Network Attached Storage (NAS), a Personal Computer (PC), a Television (TV), a teller machine, or a self-service machine. This is not specifically limited in this embodiment of this application.

The random access apparatus in this embodiment of this application may be an apparatus with an operating system. The operating system may be an Android operating system, may be an iOS operating system, or may be another possible operating system. This is not specifically limited in this embodiment of this application.

For the apparatus 900 according to this embodiment of the present disclosure, refer to the corresponding process of the method 900 in the embodiment of the present disclosure. In addition, the units/modules in the apparatus 900 and the foregoing other operations and/or functions are respectively intended to implement the corresponding processes performed by the terminal device in the methods 200 to 700, with the same or equivalent technical effects achieved. For brevity, details are not described herein again.

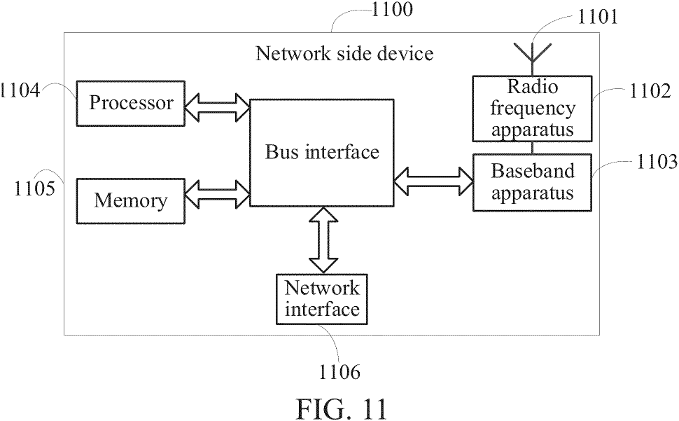

FIG. 10 is a schematic structural diagram of a random access apparatus according to an embodiment of the present disclosure. As shown in FIG. 10, the random access apparatus 1000 includes a second receiving module 1010 and a second processing module 1020.

The second receiving module 1010 is configured to receive first information for random access, where a preamble carried in the first information is determined based on information of a plurality of target signals.

The second processing module 1020 is configured to transmit second information, where the second information is a random access response for the first information.

In an implementation, the second processing module 1020 is configured to: before the first information for random access is received, transmitting random access-related signaling used for indicating the plurality of target signals.

In an implementation, the second processing module 1020 is configured to: during the receiving of the first information used for random access, in a case that a plurality of uplink carriers are configured for the terminal device and target measurement values corresponding to the plurality of target signals meet a first condition, receive the first information by using a target carrier in the plurality of uplink carriers.

In an implementation, that the second processing module 1020 is configured to: in a case that a plurality of uplink carriers are configured for the terminal device and target measurement values corresponding to the plurality of target signals meet a first condition, receive the first information by using a target carrier in the plurality of uplink carriers includes:
in a case that the target measurement values corresponding to the plurality of target signals are greater than a fourth threshold, receiving the first information by using a first carrier in the plurality of uplink carriers; or
in a case that a target measurement value corresponding to at least one of the plurality of target signals is not greater than the fourth threshold, receiving the first information by using a second carrier in the plurality of uplink carriers, where a frequency of the first carrier is higher than that of the second carrier.

In an implementation, a transmitting manner of transmitting the second information includes one of the following manners:
transmitting a plurality of pieces of second information based on a plurality of quasi-co-location-related parameters corresponding to the plurality of target signals;
transmitting the second information based on at least one first quasi-co-location-related parameter corresponding to the plurality of target signals; or
transmitting the second information based on a second quasi-co-location-related parameter, where the second quasi-co-location-related parameter is different from the plurality of quasi-co-location-related parameters corresponding to the plurality of target signals.

In an implementation, in a case that the number of APs associated with the plurality of target signals is greater than or equal to 2, a second time interval between a time at which the terminal device transmits the first information and a time at which the terminal device receives the second information is greater than or equal to a first time interval, where the first time interval is a time interval between a time at which the terminal device transmits the first information and a time at which the terminal device receives the second information in a case that the number of APs associated with the plurality of target signals is 1.

In an implementation, the second information includes first parameter information, and the first parameter information is different from the information of the target signal.

In an implementation, the first parameter information includes at least one of an AP, a TRP, a beam, quasi-co-location, and a transmission configuration indicator TCI.

In an implementation, the second information is used for scheduling the terminal device to transmit third information, and the method further includes:
receiving the third information, where the third information carries at least one of a PUSCH and a DMRS; and
transmitting fourth information to the terminal device, where the fourth information is response information for the third information.

In an implementation, the second processing module 1020 is configured to transmit, only in a case that the preamble in the first information is obtained, the second information used for scheduling the terminal device to transmit the third information.

In an implementation, the first information is an MSGA in a two-step random access procedure, and/or the second information is an MSGB in the two-step random access procedure.

The random access apparatus in this embodiment of this application may be an apparatus, or may be a component, an integrated circuit, or a chip in a terminal. The apparatus may be a mobile electronic device, or may be a non-mobile electronic device. For example, the mobile electronic device may be a mobile phone, a tablet computer, a notebook computer, a palmtop computer, a vehicle-mounted electronic device, a wearable device, a UMPC, a netbook, or a PDA, and the non-mobile electronic device may be a server, an NAS, a PC, a Television (TV), a teller machine, or a self-service machine. This is not specifically limited in this embodiment of this application.

The random access apparatus in this embodiment of this application may be an apparatus with an operating system. The operating system may be an Android operating system, may be an iOS operating system, or may be another possible operating system. This is not specifically limited in this embodiment of this application.

For the apparatus 1000 according to this embodiment of the present disclosure, refer to the corresponding process of the method 1000 in the embodiment of the present disclosure. In addition, the units/modules in the apparatus 1000 and the foregoing other operations and/or functions are respectively intended to implement the corresponding processes performed by the network device in the methods 700 to 800, with the same or equivalent technical effects achieved. For brevity, details are not described herein again.

An embodiment of this application further provides a network side device. As shown in FIG. 11, the network side device 1100 includes an antenna 1101, a radio frequency apparatus 1102, and a baseband apparatus 1103. The antenna 1101 is connected to the radio frequency apparatus 1102. In an uplink direction, the radio frequency apparatus 1102 receives information by using the antenna 1101, and transmits the received information to the baseband apparatus 1103 for processing. In a downlink direction, the baseband apparatus 1103 processes to-be-transmitted information, and transmits the information to the radio frequency apparatus 1102; and the radio frequency apparatus 1102 processes the received information and then transmits the information by using the antenna 1101.

The frequency band processing apparatus may be located in the baseband apparatus 1103. The method performed by the network side device in the foregoing embodiments may be implemented by the baseband apparatus 1103, and the baseband apparatus 1103 includes a processor 1104 and a memory 1105.

The baseband apparatus 1103 may include, for example, at least one baseband processing unit, where a plurality of chips are disposed on the baseband processing unit. As shown in the figure, one of the chips is, for example, the processor 1104, and connected to the memory 1105, to invoke the program in the memory 1105 to perform the operations of the network device shown in the foregoing method embodiment.

The baseband apparatus 1103 may further include a network interface 1106, configured to exchange information with the radio frequency apparatus 1102. The interface is, for example, a Common Public Radio Interface (CPRI).

For example, the network side device in this embodiment of the present disclosure further includes instructions or a program stored in the memory 1105 and capable of running on the processor 1104, and the processor 1104 invokes the instructions or program in the memory 1105 to perform the following operations:
receiving first information for random access, where a preamble carried in the first information is determined based on information of a plurality of target signals; and
transmitting second information, where the second information is a random access response for the first information.

In an implementation, before the first information for random access is received, the network device transmits random access-related signaling used for indicating the plurality of target signals.

In an implementation, the receiving first information used for random access includes:
in a case that a plurality of uplink carriers are configured for the terminal device and target measurement values corresponding to the plurality of target signals meet a first condition, receiving the first information by using a target carrier in the plurality of uplink carriers.

In an implementation, the in a case that a plurality of uplink carriers are configured for the terminal device and target measurement values corresponding to the plurality of target signals meet a first condition, receiving the first information by using a target carrier in the plurality of uplink carriers includes:
in a case that the target measurement values corresponding to the plurality of target signals are greater than a fourth threshold, receiving the first information by using a first carrier in the plurality of uplink carriers; or
in a case that a target measurement value corresponding to at least one of the plurality of target signals is not greater than the fourth threshold, receiving the first information by using a second carrier in the plurality of uplink carriers, where a frequency of the first carrier is higher than that of the second carrier.

In an implementation, a transmitting manner of transmitting the second information includes one of the following manners:
transmitting a plurality of pieces of second information based on a plurality of quasi-co-location-related parameters corresponding to the plurality of target signals;
transmitting the second information based on at least one first quasi-co-location-related parameter corresponding to the plurality of target signals; or
transmitting the second information based on a second quasi-co-location-related parameter, where the second quasi-co-location-related parameter is different from the plurality of quasi-co-location-related parameters corresponding to the plurality of target signals.

In an implementation, in a case that the number of APs associated with the plurality of target signals is greater than or equal to 2, a second time interval between a time at which the terminal device transmits the first information and a time at which the terminal device receives the second information is greater than or equal to a first time interval, where the first time interval is a time interval between a time at which the terminal device transmits the first information and a time at which the terminal device receives the second information in a case that the number of APs associated with the plurality of target signals is 1.

In an implementation, the second information includes first parameter information, and the first parameter information is different from the information of the target signal.

In an implementation, the first parameter information includes at least one of an AP, a TRP, a beam, quasi-co-location, and a transmission configuration indicator TCI. In an implementation, the second information is used for scheduling the terminal device to transmit third information, and the method further includes:
receiving the third information, where the third information carries at least one of a PUSCH and a DMRS; and
transmitting fourth information to the terminal device, where the fourth information is response information for the third information.

In an implementation, the transmitting second information includes:
transmitting, only in a case that the preamble in the first information is obtained, the second information used for scheduling the terminal device to transmit the third information.

In an implementation, the first information is an MSGA in a two-step random access procedure, and/or the second information is an MSGB in the two-step random access procedure.

Specific steps performed by the processor 1104 are the same as the method steps performed by the network device in FIG. 7 and FIG. 8, with the same technical effects achieved. To avoid repetition, details are not described herein again.

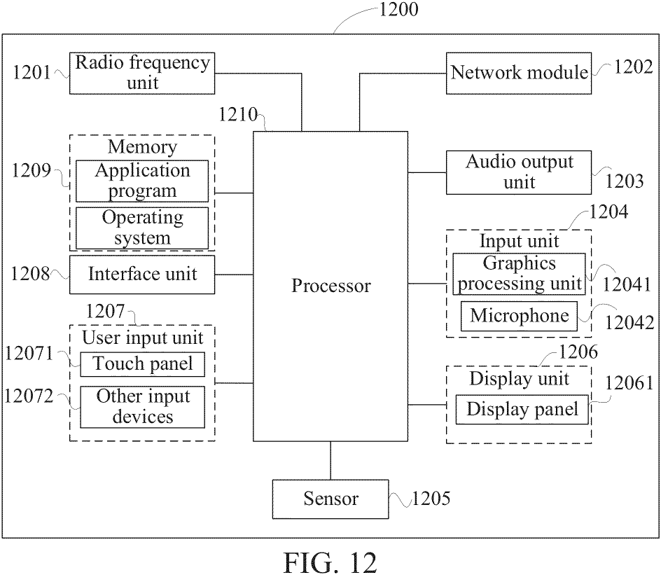

FIG. 12 is a schematic diagram of a hardware structure of a terminal device for implementing an embodiment of this application.

The terminal device 1200 includes but is not limited to components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

Persons skilled in the art can understand that the terminal device 1200 may further include a power supply (for example, a battery) that supplies power to each component. The power supply may be logically connected to the processor 1210 by using a power management system, to implement functions such as charging management, discharging management, and power consumption management by using the power management system. The terminal device structure shown in the figure does not constitute a limitation on the terminal device. The terminal device may include more or fewer components than those shown in the figure, or some components may be combined, or there may be a different component layout. Details are not described herein again.

It should be understood that, in this embodiment of this application, the input unit 1204 may include a Graphics Processing Unit (GPU) 12041 and a microphone 12042. The graphics processing unit 12041 processes image data of a static picture or a video that is obtained by an image capture apparatus (for example, a camera) in a video capture mode or an image capture mode. The display unit 1206 may include the display panel 12061. The display panel 12061 may be configured in a form of a liquid crystal display, an organic light-emitting diode, or the like. The user input unit 1207 includes a touch panel 12071 and other input devices 12072. The touch panel 12071 is also referred to as a touchscreen. The touch panel 12071 may include two parts: a touch detection apparatus and a touch controller. The other input devices 12072 may include but are not limited to a physical keyboard, a function key (such as a volume control key or an on/off key), a trackball, a mouse, and a joystick. Details are not described herein.

In this embodiment of this application, the radio frequency unit 1201 receives downlink data from a network side device and then transmits the downlink data to the processor 1210 for processing; and transmits uplink data to the network side device. Usually, the radio frequency unit 1201 includes but is not limited to an antenna, at least one amplifier, a transceiver, a coupler, a low noise amplifier, a duplexer, and the like.

The memory 1209 may be configured to store software programs or instructions and various data. The memory 1209 may mainly include a program or instruction storage region and a data storage region. The program or instruction storage region may store an operating system, an application program or instructions required by at least one function (for example, an audio play function or an image play function), and the like. In addition, the memory 1209 may include a high-speed random access memory, or may include a non-volatile memory, where the non-volatile memory may be a Read-Only Memory (ROM), a Programmable ROM (PROM), an Erasable PROM (EPROM), an Electrically EPROM (EEPROM), or a flash memory, for example, at least one magnetic disk storage device, a flash memory, or another non-volatile solid-state storage device.

The processor 1210 may include one or more processing units. In some embodiments, the processor 1210 may integrate an application processor and a modem processor. The application processor mainly processes an operating system, a user interface, an application program or instructions, and the like. The modem processor mainly processes wireless communication, for example, a baseband processor. It may be understood that the modem processor may not be integrated in the processor 1210.

The processor 1210 is configured to:
transmit first information used for random access, where a preamble carried in the first information is determined based on information of a plurality of target signals; and
receive second information transmitted by a network device, where the second information is a random access response for the first information.

In an implementation, the information of the plurality of target signals varies, and the information of the target signal is at least one of the following:
an index of the target signal, a synchronization raster sync raster, a frequency domain resource, a time domain resource, a sequence format, a quasi-co-location-related parameter, a beam, a transmission configuration indicator TCI, and an associated transmitting receiving point TRP and access point AP.

In an implementation, before the transmitting first information used for random access, the method further includes:
measuring a downlink signal; and
determining the plurality of target signals based on a measurement result of the downlink signal, where target measurement values corresponding to the plurality of target signals meet at least one of the following preset conditions:
   the target measurement values corresponding to the plurality of target signals are greater than or equal to a first threshold; or
   a difference between a plurality of target measurement values corresponding to the plurality of target signals is less than or equal to a second threshold, where
   the target measurement values are at least one of a reference signal received power RSRP, a signal-to-noise and interference ratio SINR, and reference signal received quality RSRQ.

In an implementation, the first threshold and/or the second threshold are configured by a network device for the terminal device.

In an implementation, a physical uplink shared channel PUSCH is transmitted in a case that the target measurement values are the RSRP and RSRP values of the plurality of target signal s are all greater than or equal to a third threshold, where the PUSCH is included in the first information or is transmitted after the first information, and the third threshold is greater than or equal to the first threshold.

In an implementation, the transmitting first information used for random access includes:
transmitting the first information used for random access in a case that the target measurement values are the RSRP and RSRP values of the plurality of target signals are all less than a third threshold, where the third threshold is greater than or equal to the first threshold.

In an implementation, the plurality of target signals are indicated by a network device by using random access-related signaling.

In an implementation, the random access-related signaling carries at least one of the following information:

an index of the preamble, a physical random access channel PRACH mask index, and information about a carrier for transmitting the first information.

In an implementation, there is an association relationship between the information of the target signal and the parameter of the preamble, where
the parameter of the preamble includes at least one of the index of the preamble, a frequency domain resource of the preamble, and a time domain resource of the preamble.

In an implementation, there is an association relationship between the index of the preamble and a preamble sequence format, and the preamble sequence format includes at least one of a sequence length, a subcarrier spacing SCS, and a root sequence.

In an implementation, the information of the plurality of target signals includes a difference between a plurality of target measurement values corresponding to the plurality of target signals.

In an implementation, the association relationship between the information of the target signal and the parameter of the preamble is a one-to-one correspondence.

In an implementation, before the transmitting first information used for random access, the method further includes:
determining, based on the association relationship between the information of the target signal and the parameter of the preamble, parameters of the preamble that correspond to the information of the plurality of target signals.

In an implementation, the determining, based on the association relationship between the information of the target signal and the parameter of the preamble, parameters of the preamble that correspond to the information of the plurality of target signals includes:
determining random access occasions ROs associated with the plurality of target signals; and
determining a first target preamble from a plurality of preambles corresponding to the ROs associated with the plurality of target signals.

In an implementation, the determining, based on the association relationship between the information of the target signal and the parameter of the preamble, parameters of the preamble that correspond to the information of the plurality of target signals includes:
determining ROs associated with the plurality of target signals;
selecting one RO from the ROs associated with the plurality of target signals, where a preamble corresponding to the selected RO is used as a preamble candidate set; and
determining a second target preamble from the preamble candidate set.

In an implementation, after the transmitting first information used for random access, the method further includes:
retransmitting the first information in a case that no second information transmitted by the network device is received within a first time range; and
falling back to a four-step random access procedure in a case that the number of retransmissions of the first information reaches a threshold.

In an implementation, the falling back to a four-step random access procedure includes:
transmitting first access information of the four-step random access procedure, where a preamble carried in the first access information is determined based on information of a plurality of target signals;
receiving second access information of the four-step random access procedure that is transmitted by the network device, where the second access information is a random access response for the first access information;
transmitting third access information of the four-step random access procedure based on the second access information; and
receiving fourth access information of the four-step random access procedure that is transmitted by the network device, where the fourth access information is response information for the third access information.

In an implementation, the first information further includes at least one of an uplink shared channel PUSCH and a demodulation reference signal DMRS, and transmission information of the uplink shared channel PUSCH or transmission information of the demodulation reference signal DMRS is determined based on the preamble.

In an implementation, the PUSCH includes at least one of the following:
at least one target signal that meets an RSRP threshold; or
an RSRP value of at least one target signal that meets an RSRP threshold.

In an implementation, the transmitting first information used for random access includes:
in a case that a plurality of uplink carriers are configured for the terminal device and target measurement values corresponding to the plurality of target signals meet a first condition, transmitting the first information by using a target carrier in the plurality of uplink carriers.

In an implementation, the in a case that a plurality of uplink carriers are configured for the terminal device and target measurement values corresponding to the plurality of target signals meet a first condition, transmitting the first information by using a target carrier in the plurality of uplink carriers includes:
in a case that the target measurement values corresponding to the plurality of target signals are greater than a fourth threshold, transmitting the first information by using a first carrier in the plurality of uplink carriers; or
in a case that a target measurement value corresponding to at least one of the plurality of target signals is not greater than the fourth threshold, transmitting the first information by using a second carrier in the plurality of uplink carriers, where a frequency of the first carrier is higher than that of the second carrier.

In an implementation, before the transmitting first information used for random access, the method further includes:
determining a random access radio network temporary identifier RNTI based on the target carrier.

In an implementation, before the transmitting first information used for random access, the method further includes:
determining a transmit power for the first information for random access based on path loss values of the plurality of target signals, where
each target signal corresponds to a respective path loss value.

In an implementation, the transmitting first information used for random access includes:
transmitting the first information to a plurality of associated TRPs or APs through a plurality of beams respectively, where the plurality of beams correspond to one or more panels of the terminal device.

In an implementation, the receiving second information transmitted by a network device includes one of the following manners:
receiving a plurality of pieces of second information based on a plurality of quasi-co-location-related parameters corresponding to the plurality of target signals;
receiving the second information based on at least one first quasi-co-location-related parameter corresponding to the plurality of target signals; or
receiving the second information based on a second quasi-co-location-related parameter, where the second quasi-co-location-related parameter is different from the plurality of quasi-co-location-related parameters corresponding to the plurality of target signals.

In an implementation, in a case that the number of APs associated with the plurality of target signals is greater than or equal to 2, a second time interval between a time at which the terminal device transmits the first information and a time at which the terminal device receives the second information is greater than or equal to a first time interval, where the first time interval is a time interval between a time at which the terminal device transmits the first information and a time at which the terminal device receives the second information in a case that the number of APs associated with the plurality of target signals is 1.

In an implementation, the second information includes first parameter information, and the first parameter information is different from the information of the target signal.

In an implementation, the first parameter information includes at least one of an AP, a TRP, a beam, quasi-co-location, and a transmission configuration indicator TCI. In an implementation, third information is transmitted based on the second information, where the second information is used for scheduling the terminal device to transmit the third information; and
fourth information transmitted by the network device is received, where the fourth information is response information for the third information.

In an implementation, the first information is an MSGA in a two-step random access procedure, and/or the second information is an MSGB in the two-step random access procedure.

For the terminal device 1200 according to this embodiment of the present disclosure, refer to the corresponding processes performed by the terminal device in the methods 200 to 700 in the embodiments of the present disclosure. In addition, the units/modules in the terminal device 1200 and the foregoing other operations and/or functions are respectively intended to implement the processes performed by the terminal device in the methods 200 to 700, with the same or equivalent technical effects achieved. For brevity, details are not described herein again.

An embodiment of this application further provides a readable storage medium. The readable storage medium stores a program or instructions. When the program or instructions are executed by a processor, the processes of the foregoing random access method embodiments are implemented, with the same technical effects achieved. To avoid repetition, details are not described herein again.

The processor is a processor in the electronic device in the foregoing embodiments. The readable storage medium includes a computer-readable storage medium, for example, a computer ROM, a RAM, a magnetic disk, or an optical disc.

An embodiment of this application further provides a chip. The chip includes a processor and a communications interface. The communications interface is coupled to the processor. The processor is configured to run a program or instructions, to implement the processes of the foregoing random access method embodiments, with the same technical effects achieved. To avoid repetition, details are not described herein again.

It should be understood that the chip provided in this embodiment of this application may also be referred to as a system-level chip, a system on chip, a chip system, a system-on-a-chip, or the like.

An embodiment of this application further provides a computer program product. The computer program product includes a processor, a memory, and a program or instructions stored in the memory and capable of running on the processor. When the program or instructions are executed by the processor, the steps of the method according to the first aspect are implemented.

It should be noted that, in this specification, the terms “include” and “comprise”, or any of their variants are intended to cover a non-exclusive inclusion, such that a process, a method, an article, or an apparatus that includes a list of elements not only includes those elements but also includes other elements that are not expressly listed, or further includes elements inherent to such a process, method, article, or apparatus. In absence of more constraints, an element preceded by “includes a...” does not preclude the existence of other identical elements in the process, method, article, or apparatus that includes the element. In addition, it should be noted that the scope of the method and apparatus in the implementations of this application is not limited to performing functions in the shown or described order, but may also include performing functions in a substantially simultaneous manner or in a reverse order depending on the functions involved. For example, the described method may be performed in an order different from that described, and steps may be added, omitted, or combined. In addition, features described with reference to some examples may be combined in other examples.

According to the foregoing description of the implementations, persons skilled in the art may clearly understand that the methods in the foregoing embodiments may be implemented by using software in combination with a necessary common hardware platform, or may be implemented by using hardware. In some embodiments, the technical solutions of this application essentially or the part contributing to the prior art may be implemented in a form of a software product. The computer software product may be stored in a storage medium (for example, a ROM/RAM, a magnetic disk, or a compact disc), and includes several instructions for instructing a terminal (which may be a mobile phone, a computer, a server, a network device, or the like) to perform the method described in each embodiment of this application.

The foregoing describes the embodiments of this application with reference to the accompanying drawings. However, this application is not limited to the foregoing specific implementations. The foregoing specific implementations are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A random access method, performed by a terminal device, comprising:
transmitting first information used for random access, wherein a preamble carried in the first information is determined based on information of a plurality of target signals; and
receiving second information transmitted by a network device, wherein the second information is a random access response for the first information.

2. The random access method according to claim 1, wherein the information of the plurality of target signals varies, and the information of the target signal is at least one of the following:
an index of the target signal, a synchronization raster (sync raster), a frequency domain resource, a time domain resource, a sequence format, a quasi-co-location-related parameter, a beam, a Transmission Configuration Indicator (TCI), or an associated Transmission Reception Point (TRP) and Access Point (AP).

3. The random access method according to claim 1, wherein before the transmitting first information used for random access, the method further comprises:
measuring a downlink signal; and
determining the plurality of target signals based on a measurement result of the downlink signal, wherein target measurement values corresponding to the plurality of target signals meet at least one of the following preset conditions:
the target measurement values corresponding to the plurality of target signals are greater than or equal to a first threshold; or
a difference between a plurality of target measurement values corresponding to the plurality of target signals is less than or equal to a second threshold, wherein
the target measurement values are at least one of a Reference Signal Received Power (RSRP), a signal-to-noise and interference ratio (SINR), or Reference Signal Received Quality (RSRQ).

4. The random access method according to claim 3, wherein the first threshold or the second threshold are configured by the network device for the terminal device.

5. The random access method according to claim 3, wherein a Physical Uplink Shared Channel (PUSCH) is transmitted in a case that the target measurement values are the RSRP and RSRP values of the plurality of target signals are all greater than or equal to a third threshold, wherein the PUSCH is comprised in the first information or is transmitted after the first information, and the third threshold is greater than or equal to the first threshold.

6. The random access method according to claim 3, wherein the transmitting first information used for random access comprises:
transmitting the first information used for random access in a case that the target measurement values are the RSRP and RSRP values of the plurality of target signals are all less than a third threshold, wherein the third threshold is greater than or equal to the first threshold.

7. The random access method according to claim 1, wherein the plurality of target signals are indicated by the network device by using random access-related signaling.

8. The random access method according to claim 7, wherein the random access-related signaling carries at least one of the following information:
an index of the preamble, a Physical Random Access Channel (PRACH) mask index, or information about a carrier for transmitting the first information.

9. The random access method according to claim 1, wherein
there is an association relationship between the information of the target signal and a parameter of the preamble, and
the parameter of the preamble comprises at least one of the index of the preamble, a frequency domain resource of the preamble, or a time domain resource of the preamble.

10. The random access method according to claim 9, wherein there is an association relationship between the index of the preamble and a preamble sequence format, and the preamble sequence format comprises at least one of a sequence length, a Subcarrier Spacing (SCS), or a root sequence.

11. The random access method according to claim 9, wherein the information of the plurality of target signals comprises a difference between a plurality of target measurement values corresponding to the plurality of target signals.

12. The random access method according to claim 9, wherein the association relationship between the information of the target signal and the parameter of the preamble is a one-to-one correspondence.

13. The random access method according to claim 9, wherein before the transmitting first information used for random access, the method further comprises:
determining, based on the association relationship between the information of the target signal and the parameter of the preamble, parameters of the preamble that correspond to the information of the plurality of target signals.

14. The random access method according to claim 13, wherein the determining, based on the association relationship between the information of the target signal and the parameter of the preamble, parameters of the preamble that correspond to the information of the plurality of target signals comprises:
determining Random access Occasions (Ros) associated with the plurality of target signals; and
determining a first target preamble from a plurality of preambles corresponding to the ROs associated with the plurality of target signals.

15. The random access method according to claim 13, wherein the determining, based on the association relationship between the information of the target signal and the parameter of the preamble, parameters of the preamble that correspond to the information of the plurality of target signals comprises:
determining Random access Occasions (Ros) associated with the plurality of target signals,
selecting one RO from the ROs associated with the plurality of target signals, wherein a preamble corresponding to the selected RO is used as a preamble candidate set, and
determining a second target preamble from the preamble candidate set.

16. The random access method according to claim 1, wherein after the transmitting first information used for random access, the method further comprises:
retransmitting the first information in a case that no second information transmitted by the network device is received within a first time range; and
falling back to a four-step random access procedure in a case that the number of retransmissions of the first information reaches a threshold.

17. The random access method according to claim 16, wherein the falling back to a four-step random access procedure comprises:
transmitting first access information of the four-step random access procedure, wherein a preamble carried in the first access information is determined based on information of a plurality of target signals;
receiving second access information of the four-step random access procedure that is transmitted by the network device, wherein the second access information is a random access response for the first access information;
transmitting third access information of the four-step random access procedure based on the second access information; and
receiving fourth access information of the four-step random access procedure that is transmitted by the network device, wherein the fourth access information is response information for the third access information.

18. The random access method according to claim 1, wherein the first information further comprises at least one of a Physical Uplink Shared Channel (PUSCH) or a Demodulation Reference Signal (DMRS), wherein transmission information of the PUSCH or transmission information of the DMRS is determined based on the preamble.

19. A random access method, performed by a network device, comprising:
receiving first information for random access, wherein a preamble carried in the first information is determined based on information of a plurality of target signals; and
transmitting second information, wherein the second information is a random access response for the first information.

20. A terminal device, comprising a processor; a memory having a computer program stored thereon, wherein the computer program, when executed by the processor, causes the computer program to perform operations comprising:
transmitting first information used for random access, wherein a preamble carried in the first information is determined based on information of a plurality of target signals; and
receiving second information transmitted by a network device, wherein the second information is a random access response for the first information.
